(19) United States
(12) Patent Application Publication
(10) Pub. No.: US 2010/0253043 A1
(43) Pub. Date: Oct. 7, 2010

(54) Rear Gate with Open Step-Through Area

(75) Inventors: Robert M. Gast, Cresco, IA (US); Scott R. Ollendieck, Cresco, IA (US); Randy J. Svoboda, Cresco, IA (US); John C. Swestka, Protovin, IA (US)

Correspondence Address: MERCHANT & GOULD PC, P.O. BOX 2903, MINNEAPOLIS, MN, 55402-0903, US

(73) Assignee: FEATHERLITE, INC., Cresco, IA (US)

(21) Appl. No.: 12/749,116

(22) Filed: Mar. 29, 2010

Related U.S. Application Data
(60) Provisional application No. 61/165,676, filed on Apr. 1, 2009.

(51) Int. Cl. B62D 53/06; B62D 33/00

(52) U.S. Cl. 280/423.1; 296/50

(57) ABSTRACT

A rear gate includes a frame with first, second, and third vertical members, a horizontal top member, and a horizontal bottom member. The first and second vertical members are connected to the horizontal top and bottom members to form a first opening between the first and second vertical members. The third vertical member is connected to the horizontal top member to form a second opening between the second and third vertical members. The horizontal bottom member only extends between the first and second vertical members so that the second opening is free of the frame at a bottom of the second opening. A first locking pipe positioned adjacent to the third vertical member to locks the rear gate in the closed gate position.

### RELATED APPLICATION

This application claims the benefit of U.S. patent application Ser. No. 61/165,676 filed on Apr. 1, 2009, the entirety of which is hereby incorporated by reference.

### BACKGROUND

Trailers are used to carry an assortment of cargo. For example, some trailers are configured to carry animals, such as livestock (e.g., pigs and cattle) or horses. The trailers typically include a rear gate that can be opened to allow the animals to enter and exit the trailer. The rear gate is closed during transport to keep the animals in the trailer. It is desirable to make it easy for the animals to enter and exit the trailer through the rear gate when loading and unloading the animals.

### SUMMARY

In one aspect, a rear gate for a trailer includes: a frame including: first, second, and third vertical members; a horizontal top member; and a horizontal bottom member; wherein the first and second vertical members are connected to the horizontal top and bottom members to form a first opening between the first and second vertical members; wherein the third vertical member is connected to the horizontal top member to form a second opening between the second and third vertical members; and wherein the horizontal bottom member only extends between the first and second vertical members so that the second opening is free of the frame at a bottom of the second opening; a first covering extending across the first opening in the frame to block the first opening; and a door positioned at the second opening, the door being moveable between a closed door position and an open door position, the door blocking the second opening when in the closed door position, and the door allowing access through the second opening when the door is in the open door position; a plurality of hinges coupled to the first vertical member to allow the rear gate to swing between a closed gate position and an open gate position; and a first locking pipe positioned adjacent to the third vertical member to lock the rear gate in the closed gate position.

In another aspect, a trailer includes: a trailer floor; a trailer frame coupled to the trailer floor, the trailer floor and the trailer frame defining a trailer interior and an open rear; and a rear gate coupled to the trailer to cover the open rear, the rear gate comprising: a frame including: first, second, and third vertical members; a horizontal top member; and a horizontal bottom member; wherein the first and second vertical members are connected to the horizontal top and bottom members to form a first opening between the first and second vertical members; wherein the third vertical member is connected to the horizontal top member to form a second opening between the second and third vertical members; and wherein the horizontal bottom member only extends between the first and second vertical members so that the second opening is free of the frame at the trailer floor extending through the second opening; a first covering extending across the first opening in the frame to block the first opening; and a door positioned at the second opening, the door being moveable between a closed door position and an open door position, the door blocking the second opening when in the closed door position, and the door allowing access through the second opening when the door is in the open door position; a plurality of hinges coupled to the first vertical member to allow the rear gate to swing between a closed gate position and an open gate position; and a first locking pipe positioned adjacent to the third vertical member to lock the rear gate in the closed gate position.

In yet another aspect, a method for closing a rear opening in a trailer includes: mounting a rear gate assembly at a rear end of a trailer, the rear gate assembly including a frame forming a first opening and a second opening, with one of the first and second openings extending to a floor of the trailer; positioning a first locking pipe to extend vertically along the frame to lock the frame in a closed gate position; opening the first locking pipe; and swinging the frame from the closed gate position to an open gate position.

### DESCRIPTION OF THE DRAWINGS

FIG. 1 is perspective view of a portion of an example trailer including an example rear gate assembly with a rear gate in a partially open gate position.

FIG. 2 is a perspective view of the rear gate assembly of FIG. 1 with a gate door in a closed door position.

FIG. 3 is a plan view of the rear gate assembly of FIG. 2.

FIG. 4 is a perspective view of the rear gate assembly of FIG. 1 with a door in an open door position.

FIG. 5 is another perspective view of the rear gate assembly of FIG. 4.

FIG. 6 is a plan view of the rear gate of FIG. 4.

FIGS. 7, 7A, and 7B are end views of the rear gate of FIG. 4.

FIG. 8 is a plan view of another rear gate assembly with a roll up door in a closed door position.

FIG. 9 is another plan view of the rear gate of FIG. 8 with the roll up door in an open door position.

FIG. 10 is a plan view of an example trailer including another example rear gate assembly with a rear gate in a closed position.

FIG. 11 is another plan view of the rear gate of FIG. 10 with a door in an open door position

### DETAILED DESCRIPTION

Example embodiments described herein are related to a rear gate for a trailer. The rear gate includes a frame having at least two panels. One panel can be moved relative to the other panel to expose a step-through opening that is free of the frame at the bottom of the frame. The step-through opening allows animals to move through the rear gate without having to step over a member of the frame.

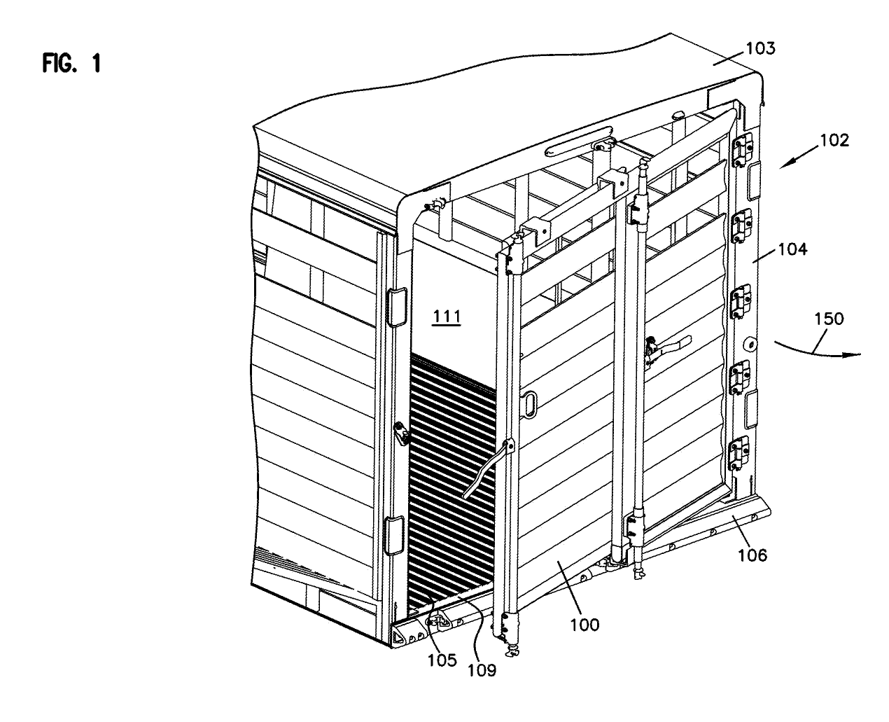

Referring now to FIG. 1, an example rear gate and frame assembly 102 including a rear gate 100 is shown.

In the example shown, the rear gate and frame assembly 102 is configured to be mounted to a rear end of a trailer 101. The rear gate and frame assembly 102 includes a frame 104 and a bumper 106. The rear gate and frame assembly 102 is typically mounted in the opening at the rear end of the trailer so that the frame 104 engages a frame 103 of the trailer 101. A floor 105 of the trailer 101 is positioned at a same level as bottom portion 109 of the frame 104.

In some embodiments, the trailer 101 is any typical trailer that is towed behind a vehicle to haul livestock and other animals. Examples of such trailers include the Bumper Pull or Gooseneck trailers manufactured by Featherlite Trailers of Cresco, Iowa. Other types of trailers can also be used.

The rear gate 100 includes a frame 110 with members 112, 114, 116, 118, 120. The horizontal member 118 is connected to vertical members 112, 114, 116. The horizontal member 120 is connected to vertical members 114, 116.

In example embodiments, the members 112, 114, 116, 118, 120 of the frame 110 are made of extruded aluminum. The members 112, 116, 118, 120 are connected at 45 degree elbows by welding or other connection techniques to form the exterior perimeter of the frame 110 of the rear gate 100. The member 114 is connected to the members 118, 120. Other materials and configurations are possible.

In the example shown, the vertical members 114, 116 define a first opening 122 therebetween, and the vertical members 112, 114 define a second opening 124 therebetween.

The first opening 122 is closed by a plurality of panels 132 that extend between the vertical members 114, 116. In the example shown, openings 134, 136 are formed in the first opening 122 between adjacent panels 132 to allow for visual inspection of an interior 111 of the trailer 101 and for airflow through the trailer 101. Other configurations are possible.

The second opening 124 is closed by a door 140 that extends between the vertical members 112, 114. In the example shown, the door 140 includes a plurality of panels 142 that extend between the vertical members 112, 114. Openings 144, 146 are formed in the door 140 between adjacent panels 142 to allow for visual inspection of the interior 111 of the trailer 101 and for airflow through the trailer 101.

The frame 110 of the rear gate 100 is mounted to the frame 104 of the rear gate and frame assembly 102 by a plurality of hinges 152 connected to the vertical member 116. The hinges 152 allow the rear gate 100 to be swung in a direction 150 (see FIG. 1) to open the rear gate 100 to allow for access to the interior 111 of the trailer 101.

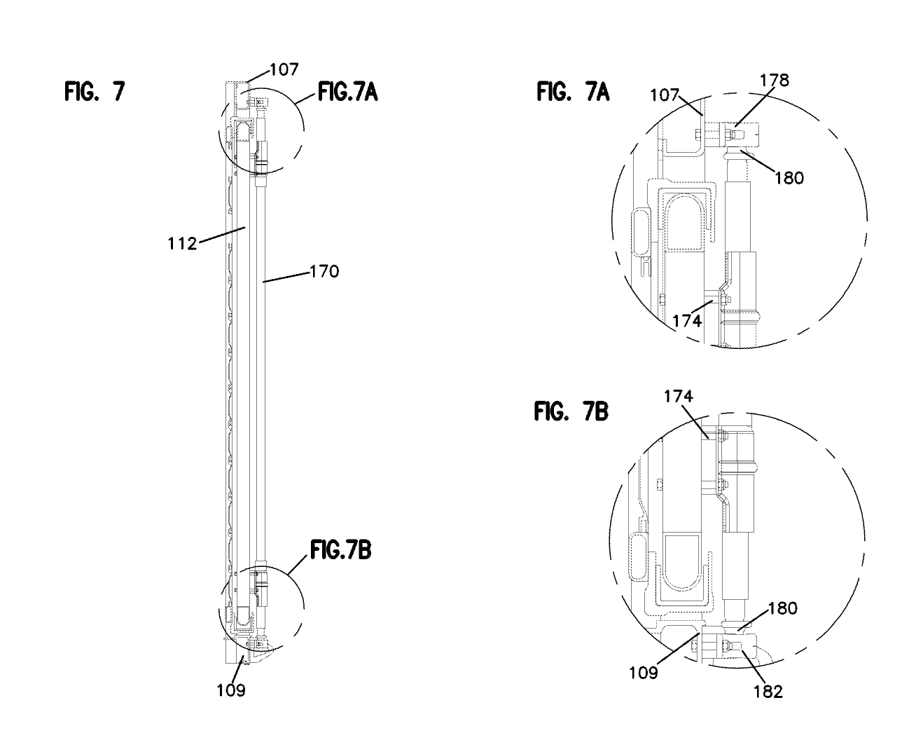

The rear gate and frame assembly 102 includes locking pipes 170, 172 that extend vertically along vertical members 112, 114 to lock the rear gate 100 in the closed position. As shown in FIGS. 7, 7A, and 7B, the locking pipes 170, 172 extend from a top portion 107 of the frame 104 to the bottom portion 109 of the frame 104 adjacent to the bumper 106 of the rear gate and frame assembly 102.

The locking pipes 170, 172 are connected to the vertical members 112, 114 by brackets 174. A first end 176 of each of the locking pipes 170, 172 engages a respective bracket 178 on the top portion 107 of the frame 104. A second end 180 of each of the locking pipes 170, 172 engages a respective bracket 182 on the bottom portion 107 of the frame 104.

A door lock 162 is connected to each of the locking pipes 170, 172. Each door lock 162 is positioned in a locking structure 164 on the frame 104 of the rear gate and frame assembly 102 for the locking pipe 170, and one of the panels 132 for the locking pipe 172. The locking structures 164 retain the door locks 162 in the locked position. The door locks 162 can be disengaged from the locking structure 164 by lifting the removing a pin and lifting the door locks 162 out of the locking structures 162. Once disengaged, the door locks 162 can be used to disengage the locking pipes 170, 172, as described below.

To disengage the locking pipes 170, 172 from the brackets 178, 182, the respective door lock 162 for each of the locking pipes 170, 172 is twisted approximately 120 degrees to twist the locking pipes 170, 172. As the locking pipes 170, 172 are twisted, the first and second ends 176, 180 are disengaged from the respective brackets 178, 182. Once the locking pipes 170, 172 are released from the brackets 178, 182, the rear gate 100 can be swung open in the direction 150. See FIG. 1.

To close the rear gate 100, the rear gate 100 is moved back to the closed position. The door locks 162 are then pivoted approximately 120 degrees in the opposite direction to engage the first and second ends 176, 180 of each of the locking pipes 170, 172 with the respective brackets 179, 182. Each door lock 162 can then be placed back into the respective locking structure 164 and the pins reinserted to lock the rear gate in the closed position.

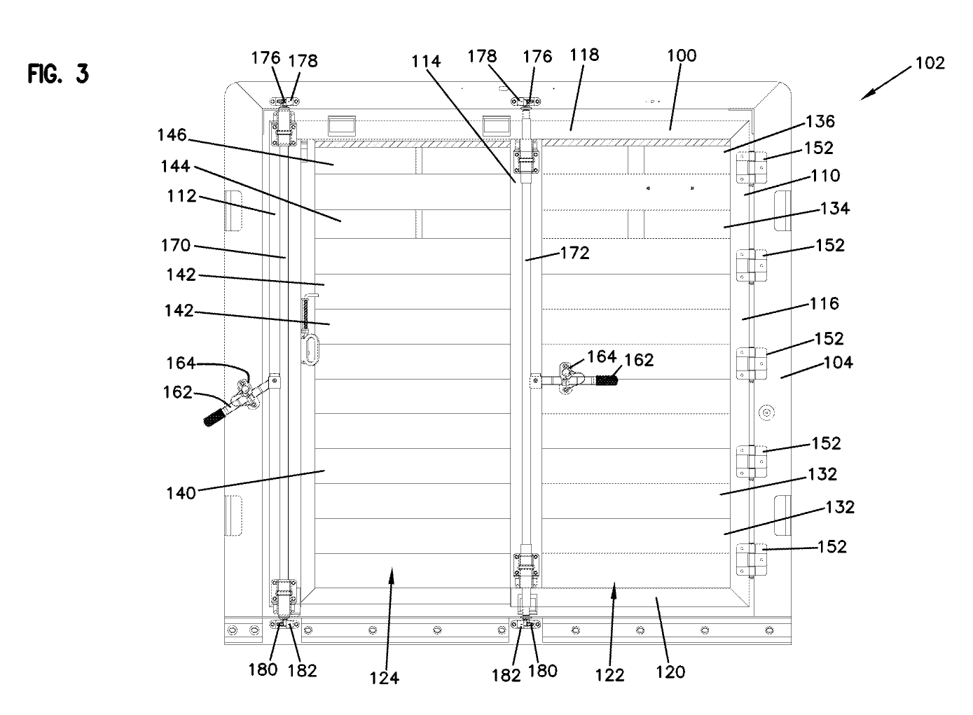

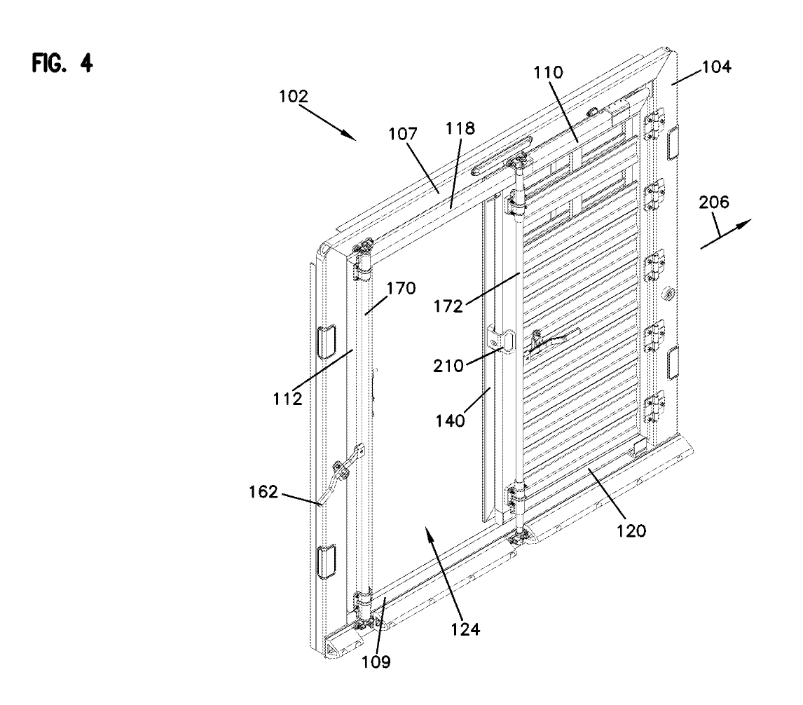

The door 140 can be used to access the interior 111 of the trailer 101 without requiring the rear gate 100 to be swung open. In the example shown, the door 140 moves between closed and open positions to allow for access to the interior 111 of the trailer 101 through the opening 124. The door 140 is shown in the closed position in FIGS. 1-3 and the open position in FIG. 4-6.

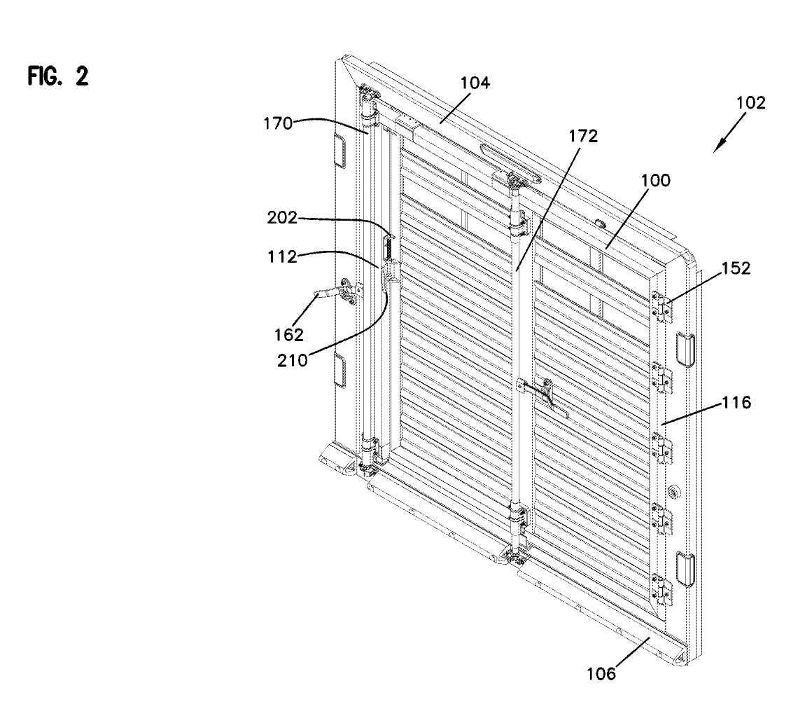

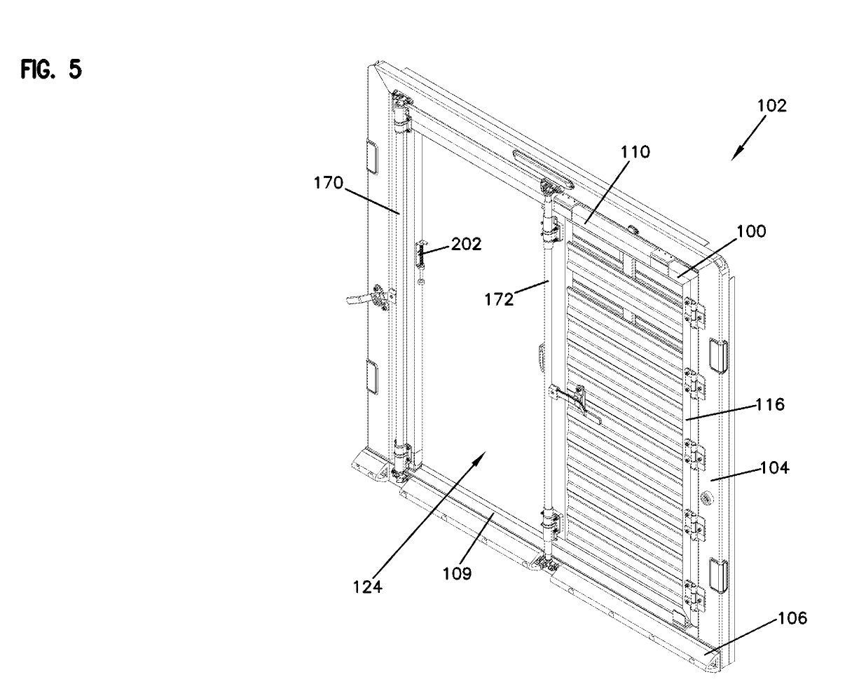

To open the door 140, a pin 202 is lifted or retracted to disengage a handle 210 of the door 140 from the vertical member 112. See FIGS. 2 and 5. Once disengaged, the handle 210 can be grasped, and the door 140 can be slid in a direction 206 to an open position so that the second opening 124 is exposed. See FIG. 4.

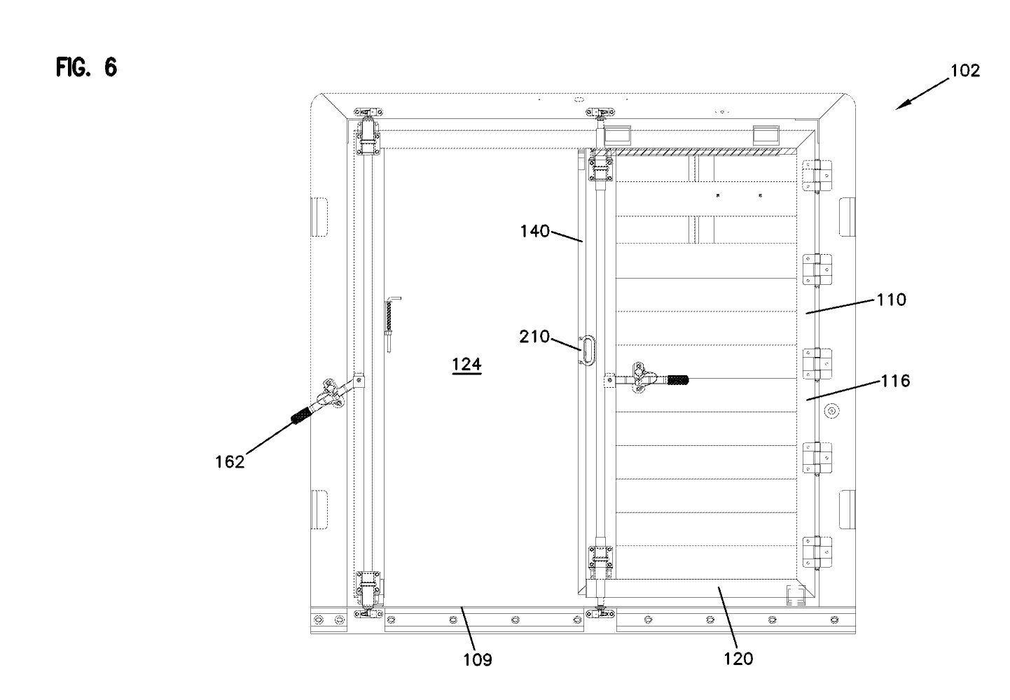

In this open position shown in FIGS. 4-6, the second opening 124 provides unobstructed access to the interior 111 of the trailer 101. In other words, a bottom portion 109 of the frame 104 of the rear gate and frame assembly 102 is free of the frame 110 so that no portion of the frame 110 of the rear gate 100 extends into the second opening 124 at the bottom portion 109 of the frame 104. As shown, the horizontal member 120 only extends between the vertical members 114, 116. See FIG. 6. In this manner, there is no part of the frame 110 of the rear gate 100 in the second opening 124 that blocks the transition from the floor 105 of the trailer to the bottom portion 109 of the frame 104.

To close the door 140, the user grasps the handle 210 and slides the door 140 to the closed position. The pin 202 is replaced to engage the door 140 to the vertical member 112 to lock the door 140 in the closed position.

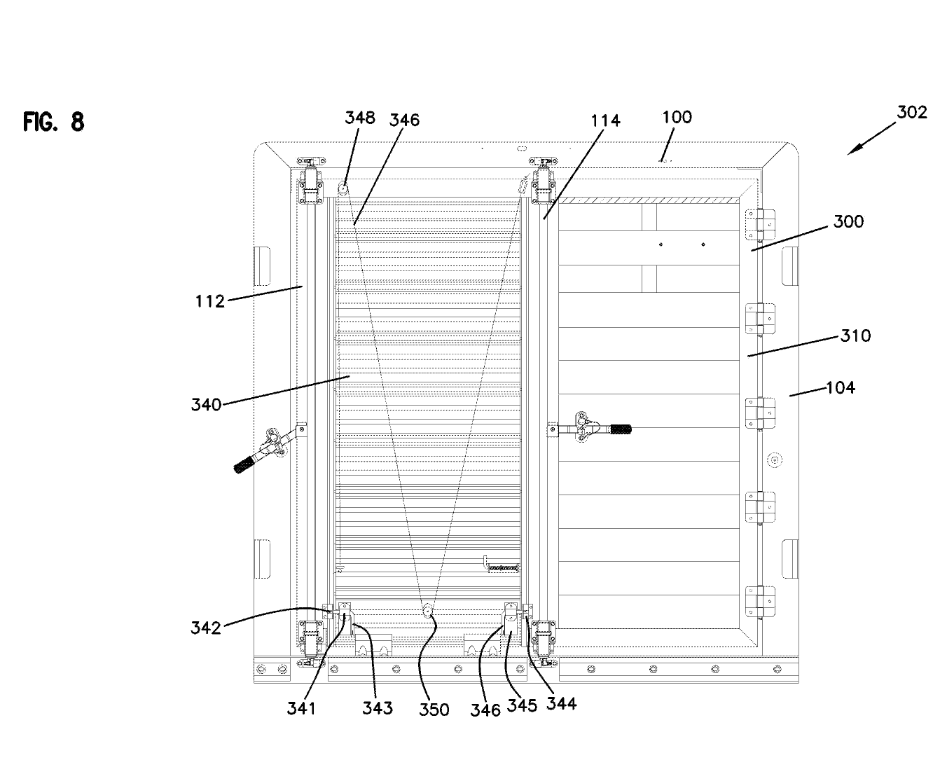

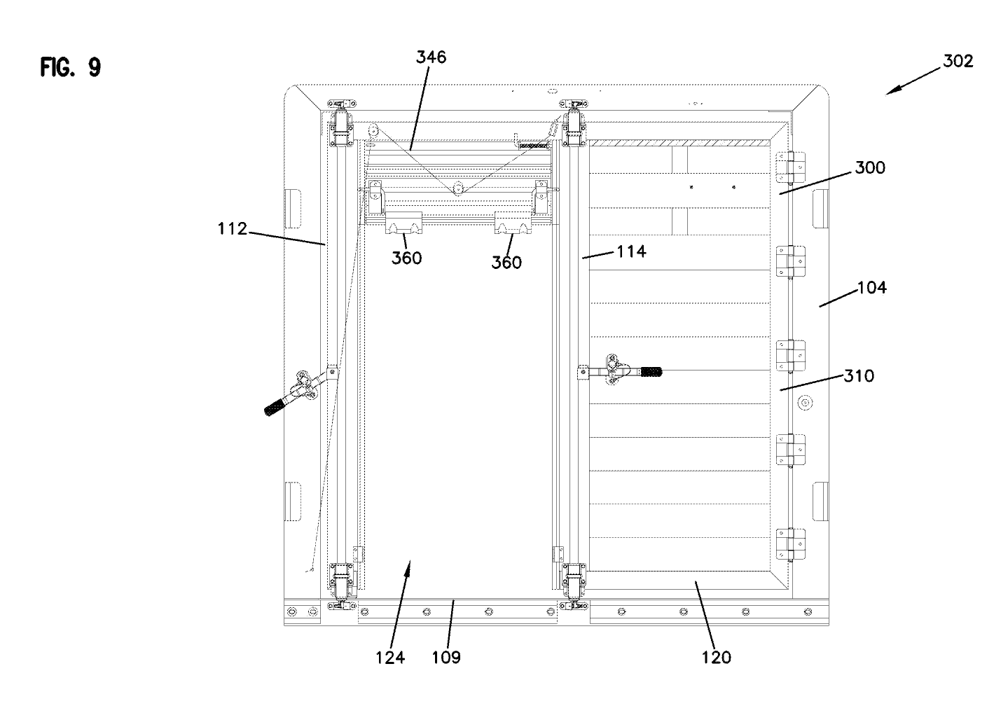

Referring now to FIGS. 8 and 9, another example rear gate and frame assembly 302 including a rear gate 300 is shown. The rear gate and frame assembly 302 is similar to the rear gate and frame assembly 102 described above, except that the rear gate and frame assembly 302 includes a door 340 that rolls vertically, rather than slides horizontally. The door 340 is shown in the closed position in FIG. 8 and the open position in FIG. 9.

The door 340 includes a cable 346 that is extended, under tension, over pulleys 348, 350. The cable 346 assists in rolling the door to the open position, as described below.

In the closed position shown in FIG. 8, latching assemblies 341, 345 on the door 340 are connected to brackets 342, 344 on members 112, 114 of a frame 310 of the rear gate 300 so that the door 340 is locked in the closed position. To unlock the door 340, pins 343, 346 are moved so that the latching assemblies 341, 345 are no longer connected to the brackets 342, 344. Once unlocked, the door 340 can be rolled up to the open position, as described below.

To move the door 340 to the open position shown in FIG. 9, the door 340 is grasped and moved upwards. The cable 346 assists in moving the door 340 to the top open position as the tension in the cable 346 is increased. Once opened, the second opening 124 provides unobstructed access to the interior 111 of the trailer 101. In other words, no portion of the frame 310 of the rear gate 300 extends into the second opening 124 at the bottom portion 109 of the frame 104 of the rear gate and frame assembly 302 because the horizontal member 120 of the frame 310 of the rear gate 300 only extends between the vertical members 114, 116.

To close the door 340, the door is moved downwards until bumpers 360 contact the bottom portion 109 of the frame 104. The pins 343, 346 are moved to reengage the latching assemblies 341, 345 with the brackets 342, 344 to lock the door 340 in the closed position.

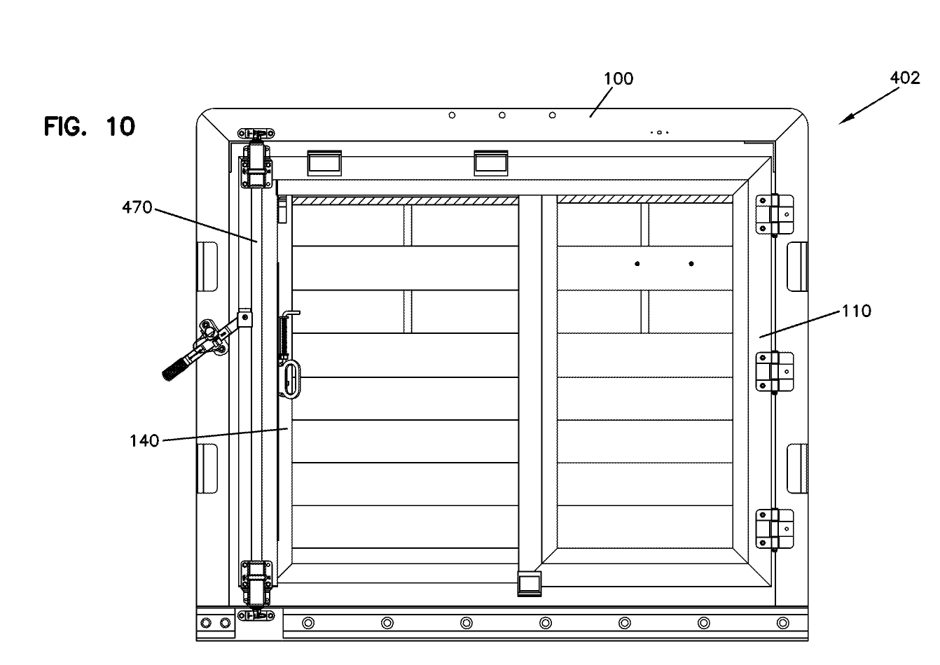

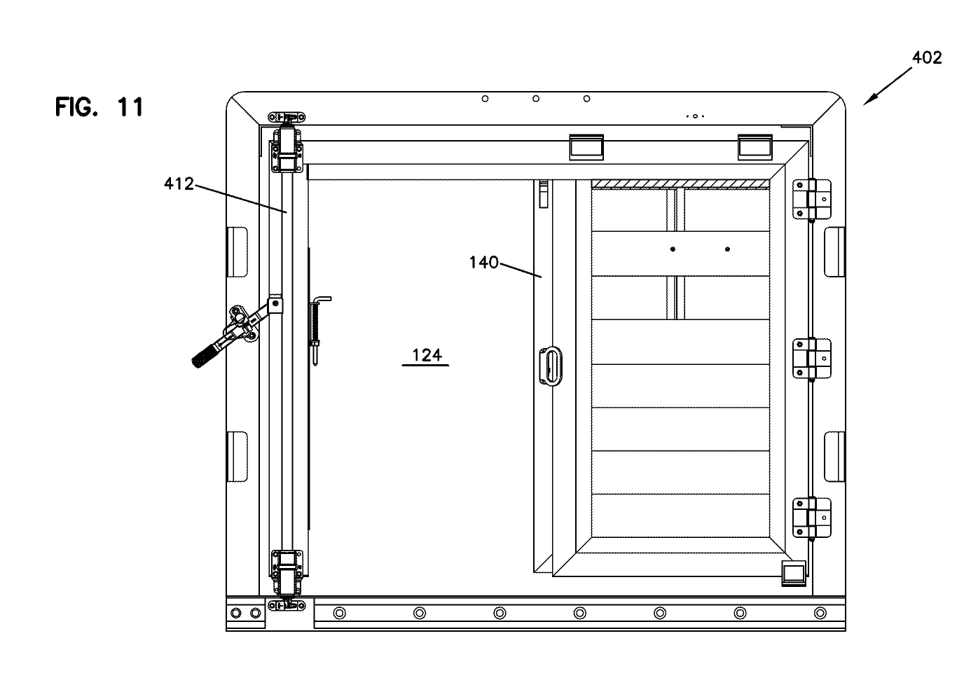

Referring now to FIGS. 10 and 11, another example rear gate assembly 402 is shown. The rear gate assembly 402 is similar in structure to that of the rear gate and frame assembly 102 described above. However, the rear gate assembly 402 includes only a single locking pipe 470 (rather than the multiple locking pipes 170, 172 used in the assembly 102). Other configurations are possible.

There are various advantages associated with the rear gate assemblies disclosed herein.

One possible advantage is that the unobstructed opening that is formed when the door of the rear gate is in the open position allows for easier loading and unloading of animals within the trailer. The lack of a frame member at the bottom of the trailer floor removes the possibility of animals tripping over or otherwise being hindered by the frame as the animals pass through the rear gate into and out of the trailer.

Another possible advantage is that the rear gate provides multiple ways to access the interior of the trailer. One way involves swinging the entire rear gate open to allow access to the interior. Another way involves opening the door of the rear gate while leaving the rear gate closed. This can be advantageous in areas in which there is limited room to swing open the entire rear door, or in situations in which greater control of the animals is necessary during loading and unloading.

Another possible advantage is the use of multiple locking pipes that are used to lock the rear gate into the closed position. In the examples shown, one locking pipe is located at approximately the outermost end of the swinging rear gate, and another locking pipe is located at approximately the mid-section of the rear gate. The two locking pipes add rigidity to the rear gate when in the closed position to minimize chances that the rear gate inadvertently opens when pressure is applied to the rear gate.

The various embodiments described above are provided by way of illustration only and should not be construed to limiting. Various modifications and changes that may be made to the embodiments described above without departing from the true spirit and scope of the disclosure.

What is claimed is:

1. A rear gate for a trailer, the rear gate comprising:
a frame including:
first, second, and third vertical members;
a horizontal top member; and
a horizontal bottom member;
wherein the first and second vertical members are connected to the horizontal top and bottom members to form a first opening between the first and second vertical members;
wherein the third vertical member is connected to the horizontal top member to form a second opening between the second and third vertical members; and
wherein the horizontal bottom member only extends between the first and second vertical members so that the second opening is free of the frame at a bottom of the second opening;
a first covering extending across the first opening in the frame to block the first opening; and
a door positioned at the second opening, the door being moveable between a closed door position and an open door position, the door blocking the second opening when in the closed door position, and the door allowing access through the second opening when the door is in the open door position;
a plurality of hinges coupled to the first vertical member to allow the rear gate to swing between a closed gate position and an open gate position; and
a first locking pipe positioned adjacent to the third vertical member to lock the rear gate in the closed gate position.

2. The rear gate of claim 1, further comprising a second locking pipe positioned adjacent to the second vertical member to lock the rear gate in the closed gate position.

3. The rear gate of claim 2, wherein the door is a sliding door.

4. The rear gate of claim 2, wherein the door is a rolling door.

5. The rear gate of claim 1, wherein the door is a sliding door.

6. The rear gate of claim 1, wherein the door is a rolling door.

7. The rear gate of claim 1, wherein the first locking pipe is disconnected to allow the rear gate to be swung from the closed gate position to the open gate position.

8. A trailer, comprising:
a trailer floor;
a trailer frame coupled to the trailer floor, the trailer floor and the trailer frame defining a trailer interior and an open rear; and
a rear gate coupled to the trailer to cover the open rear, the rear gate comprising:
a frame including:
first, second, and third vertical members;
a horizontal top member; and
a horizontal bottom member;
wherein the first and second vertical members are connected to the horizontal top and bottom members to form a first opening between the first and second vertical members;
wherein the third vertical member is connected to the horizontal top member to form a second opening between the second and third vertical members; and
wherein the horizontal bottom member only extends between the first and second vertical members so that the second opening is free of the frame at the trailer floor extending through the second opening;
a first covering extending across the first opening in the frame to block the first opening; and
a door positioned at the second opening, the door being moveable between a closed door position and an open door position, the door blocking the second opening when in the closed door position, and the door allowing access through the second opening when the door is in the open door position;
a plurality of hinges coupled to the first vertical member to allow the rear gate to swing between a closed gate position and an open gate position; and
a first locking pipe positioned adjacent to the third vertical member to lock the rear gate in the closed gate position.

9. The trailer of claim 8, further comprising a second locking pipe positioned adjacent to the second vertical member to lock the rear gate in the closed gate position.

10. The trailer of claim 9, wherein the door is a sliding door.

11. The trailer of claim 9, wherein the door is a rolling door.

12. The trailer of claim 8, wherein the door is a sliding door.

13. The trailer of claim 8, wherein the door is a rolling door.

14. The trailer of claim 8, wherein the first locking pipe is disconnected to allow the rear gate to be swung from the closed gate position to the open gate position.

15. A method for closing a rear opening in a trailer, the method comprising:
mounting a rear gate assembly at a rear end of a trailer, the rear gate assembly including a frame forming a first opening and a second opening, with one of the first and second openings extending to a floor of the trailer;
positioning a first locking pipe to extend vertically along the frame to lock the frame in a closed gate position;
opening the first locking pipe; and
swinging the frame from the closed gate position to an open gate position.

16. The method of claim 15, further comprising positioning a second locking pipe to extend vertically along the frame to lock the frame in the closed gate position.

17. The method of claim 16, further comprising sliding open a door covering one of the first and second openings in the frame.

18. The method of claim 16, further comprising rolling open a door covering one of the first and second openings in the frame.

19. The method of claim 15, further comprising sliding open a door covering one of the first and second openings in the frame.

20. The method of claim 15, further comprising rolling open a door covering one of the first and second openings in the frame.
